(19) United States
(12) Patent Application Publication
(10) Pub. No.: US 2011/0261686 A1
(43) Pub. Date: Oct. 27, 2011

(54) Priority Pause (PFC) in Virtualized/Non-Virtualized Information Handling System Environment

(76) Inventors: Saikrishna M. Kotha, Austin, TX (US); Gaurav Chawla, Austin, TX (US)

(21) Appl. No.: 12/764,232

(22) Filed: Apr. 21, 2010

(51) Int. Cl. H04L 12/24

(52) U.S. Cl. 370/230

(57) ABSTRACT

A priority based pause frame format for use with a system which enables traffic for a particular source (e.g., the source that is causing the congestion) to be paused on a particular priority queue instead of pausing the traffic for all sources. In certain embodiments, the system provides enhancements to a priority based pause frame format specified by the DCB standard. Also, in certain embodiments, the system maintains a per MAC pause/resume status at a per priority queue level on each network port in network device such as a switch or converged network adapter (CAN). In certain embodiments, the system further includes a mechanism for a congested port to generate source specific pause/resume frame. Also, in certain embodiments, the system further includes a mechanism to process queues and packets at a port receiving a pause/resume frame. Such a system advantageously enables hardware based processing of packets in each queue of a network which conforms to the DCB standard.

### BACKGROUND OF THE INVENTION

1. Field of the Invention

The present invention relates to information handling systems and more particularly to a priority pause function in virtualized and non-virtualized information handling system environments.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide various standards associated with the operation of information handling systems including networked information handling systems. One such standard is the networking Data Center Bridging (DCB) standard defined by the Institute of Electrical and Electronics Engineers (IEEE).

The DCB standard includes a capability referred to as Priority Based Flow Control (PFC). Priority based flow control allows a physical network link to be divided into logical links (e.g., eight logical links). Each logical link has its own independent queue on each network physical port, and is identified by the priority field in a virtual local area network (VLAN) header within an Ethernet frame. The PFC standard allows each logical link (priority queue) to be independently paused and resumed and in theory avoids the packet drop behavior of traditional Ethernet. Because many end devices (e.g., hundreds to thousands of servers and storage platforms) are typically connected to the network, multiple servers are sending traffic for the same priority queue. The priority queues are typically assigned based on traffic types (e.g., storage area network (SAN) traffic, local area network (LAN) traffic, management (MGMT) traffic, inter-process communication (IPC) traffic, high performance computing (HPC) traffic, etc.). For example, all servers send SAN traffic on a particular priority queue (e.g., priority 3), and send LAN traffic on another specific queue (e.g., priority 5), and MGMT traffic on another priority (e.g., priority 6). One issue relating to the PFC standard is that when a physical port is subject to congestion for a specific priority queue, the physical port pauses traffic for all the sources associated with that specific priority queue which are sending traffic to the port for the congested priority queue. This operation causes many end devices to see higher network delays due to traffic being paused, even if the devices are not what is causing the congestion. This pause operation can also cause congestion to build up in the network as each switch sends pause to the previous switch in the network.

This issue is also becoming more visible with virtualization. In the virtualized environments, each physical server executes many virtual machines (also often referred to as software servers). This can cause the number of logical servers connected to the network to grow to large numbers. This issue applies to both switch-to-switch network links and switch-to-server network links. The issue applies to switch-to-switch links because traffic from many servers traverses the switch inter-switch links (ISLs). The issue applies to switch-to-server links in virtualized environments, where many host side network interface controller (NIC) interfaces support features such as single root I/O virtualization (SR-IOV) and NIC partitioning. These features allow NIC interfaces to create many virtual interfaces (e.g., a few to hundreds), and allows hundreds of virtual machines (VMs) to share the NIC. Since a NIC physical port has only eight queues (as defined by the DCB standard), the traffic of many VMs shares the same priority queue. If one particular VM sends large amounts of data, then the edge network switch encounters congestion and generates a pause frame instruction to the NIC. The NIC then pauses the specified priority queue for all VMs, even if one particular VM is causing the congestion.

FIGS. 1A and 1B, labeled prior art, show examples of a paused frame in a system without an interface partitioning (FIG. 1A) and a system with interface partitioning (FIG. 1B). More specifically, on a NIC with no interface partitioning or SR-IOV, the IEEE PFC mechanism generally works properly. However, in the environments with NIC partitioning or SR-IOV, the NIC is shared by all the VMs running on the server. In this environment, the PFC results in pausing traffic for all VMs, even when only one VM is sending many packets and causing congestion on the switch.

Accordingly, it would be desirable to provide a system which enables traffic for a particular source (e.g., the source that is causing the congestion) to be paused on a particular priority queue instead of pausing the traffic for all sources.

### SUMMARY OF THE INVENTION

In accordance with the present invention, a priority based pause frame format for use with a system which enables traffic for a particular source (e.g., the source that is causing the congestion) to be paused on a particular priority queue instead of pausing the traffic for all sources is disclosed. In certain embodiments, the system provides enhancements to a priority based pause frame format specified by the DCB standard. Also, in certain embodiments, the system maintains a per media access control (MAC) pause/resume status at a per priority queue level on each network port in network device such as a switch or converged network adapter (CNA). In certain embodiments, the system further includes a mechanism for a congested port to generate source specific pause/resume frame. Also, in certain embodiments, the system further includes a mechanism to process queues and packets at a port receiving a pause/resume frame. Such a system advantageously enables hardware based processing of packets in each queue of a network which conforms to the DCB standard.

More specifically, in one aspect, the invention relates to a method for enabling traffic for a particular source to be paused on a particular priority queue where the particular source corresponds to a logical link of a physical network link and the physical network link includes a corresponding independent queue. The method includes identifying the physical network link by a priority field; determining when a particular source is responsible for network congestion; generating a source specific pause frame, the source specific pause frame being directed to the particular source responsible for the congestion; and, pausing traffic generated by the particular source in response to the source specific pause frame.

In another aspect, the invention relates to an apparatus for enabling traffic for a particular source to be paused on a particular priority queue where the particular source corresponds to a logical link of a physical network link, and the physical network link includes a corresponding independent queue. The apparatus includes: means for identifying the physical network link by a priority field; means for determining when a particular source is responsible for network congestion; means for generating a source specific pause frame, the source specific pause frame being directed to the particular source responsible for the congestion; and, means for pausing traffic generated by the particular source in response to the source specific pause frame.

In another aspect, the invention relates to a system which includes a source comprising a plurality of priority queues, the source corresponding to a logical link of a physical network link, and a computer readable memory. The computer readable memory stores a source specific priority based flow control (PFC) module for enabling traffic for a particular source to be paused on a particular priority queue. The particular source corresponds to a logical link of a physical network link, and the physical network link includes a corresponding independent queue. The source specific PFC module includes instructions executable by a processor for: identifying the physical network link by a priority field; determining when a particular source is responsible for network congestion; generating a source specific pause frame, the source specific pause frame being directed to the particular source responsible for the congestion; and, pausing traffic generated by the particular source in response to the source specific pause frame.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIGS. 1A and 1B, labeled prior art, show examples of a paused frame in a system without an interface partitioning and a system with interface partitioning.

FIG. 2 shows system block diagram of an information handling system.

FIG. 3 shows example packet formats for a PFC pause frame packet as well as a source specific PFC pause frame packet.

FIG. 4 shows an example of managing pauses on a per MAC and per priority pause status in network adapters and network switches.

FIG. 5 shows a flow chart of a source based pause operation for a congested switch.

FIG. 6 shows a flow chart of a pause operation for a network adapter or switch receiving a source based pause frame.

FIG. 7 shows a block diagram of an environment operating with a source specific PFC.

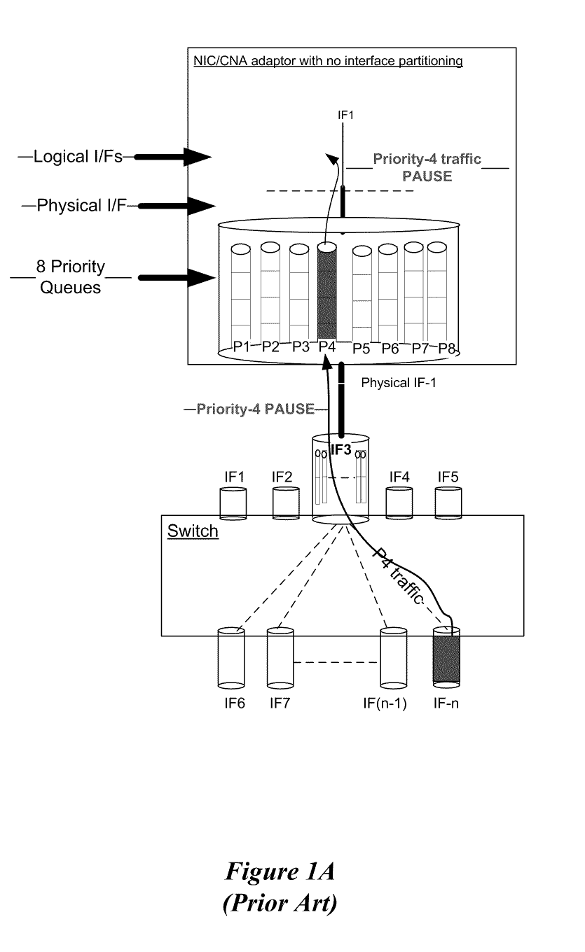

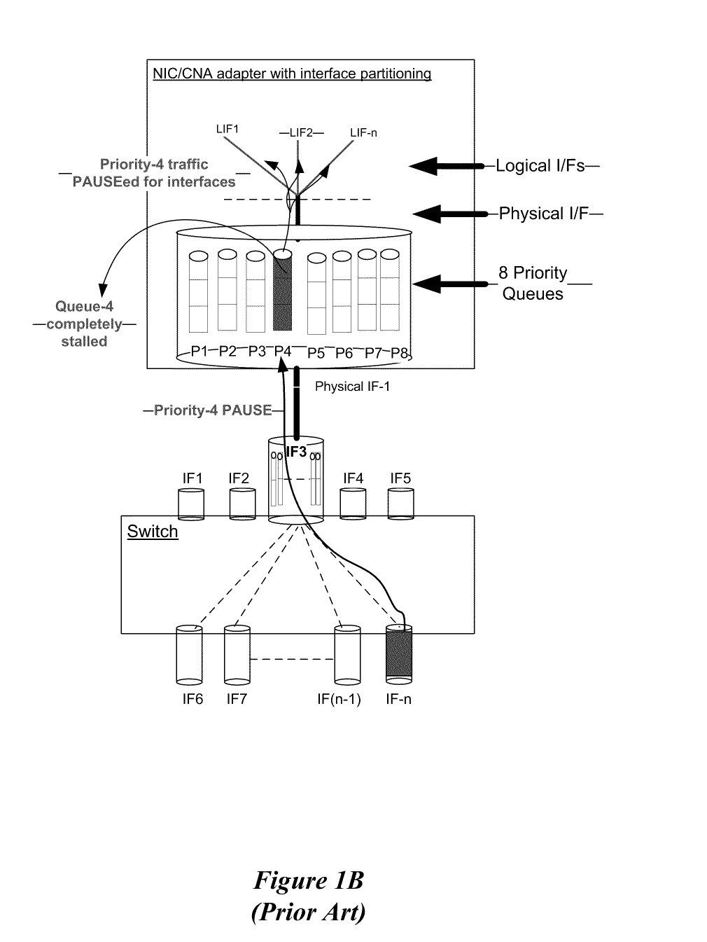

### DETAILED DESCRIPTION

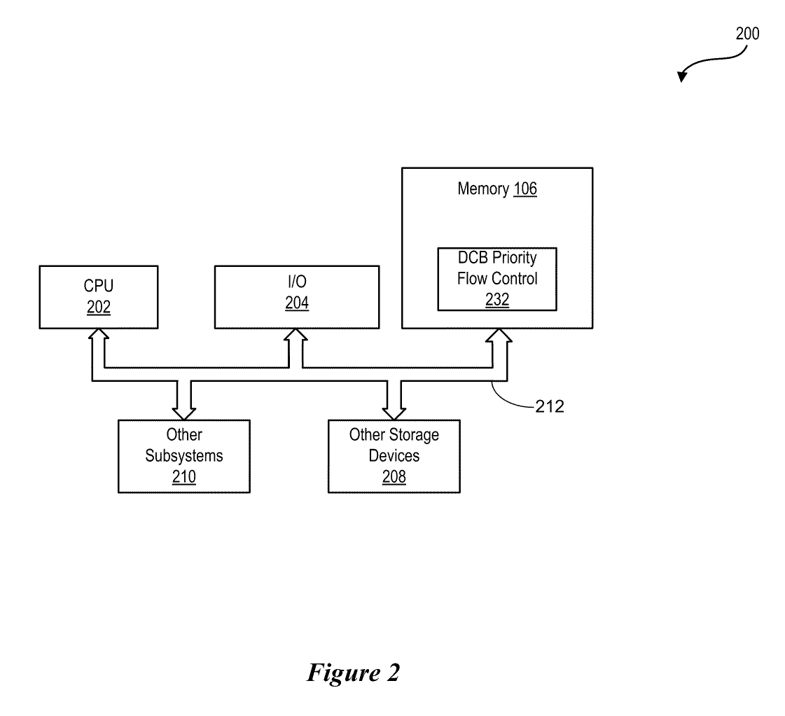

Referring briefly to FIG. 2, a system block diagram of an information handling system 200 is shown. The information handling system 200 includes a processor 202, input/output (I/O) devices 204, such as a display, a keyboard, a mouse, and associated controllers (each of which may be coupled remotely to the information handling system 200), a memory 206 including volatile memory such as random access memory (RAM) and non-volatile memory such as a hard disk and drive, and other storage devices 208, such as an optical disk and drive and other memory devices, and various other subsystems 210, all interconnected via one or more buses 212.

The memory stores a system 232 for enhancing DCB priority flow control to allow appropriate traffic from a specific source to be paused instead of performing pause/resume for all sources sending traffic for a particular priority. In various embodiments, the system conforms to the IEEE 802.1Qbb PFC standard. The system 232 includes instructions which are stored on the computer readable media (e.g., memory 206) and are executable by the processor 202.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

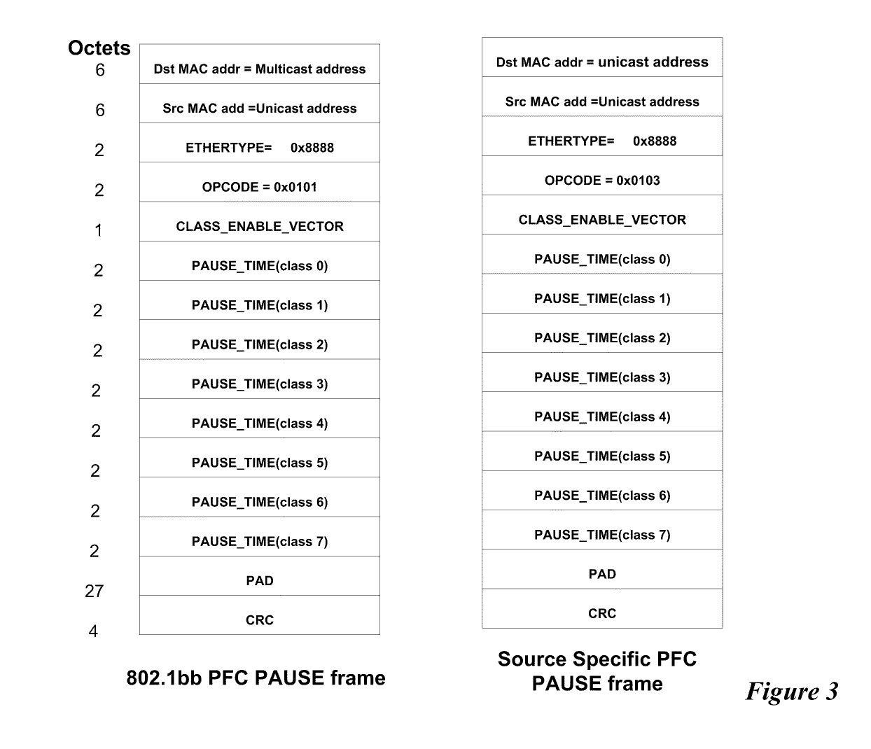

Referring to FIG. 3, example packet formats for a PFC pause frame packet as well as a source specific PFC pause frame packet are shown. The source specific PFC pause frame packet enables a congested switch to specify both source MAC address and priority queue when sending a pause frame.

By using the source specific PFC pause frame packet format, a congested switch may determine a source MAC address that it wishes to pause for a specific priority. The source specific packet format allows a switch to use a source specific source MAC address src MAC add (e.g., via a unicast address) to fill a destination MAC address Dst MAC address in the Pause frame of the packet (e.g., a unicast address) as compared with a multicase address used in a standard PFC pause frame packet.

In certain embodiments, an operation code (OPCODE) of 0x0103 (or any other reserved number) is used to specify the pause frame. In operation, handling of the source specific pause frame is different from a standard PFC frame handling. More specifically, the source specific pause frame triggers the affected priority queue to rearrange itself to transmit packets from other sources contributing to the queue while pausing packets from the source which is causing the congestion.

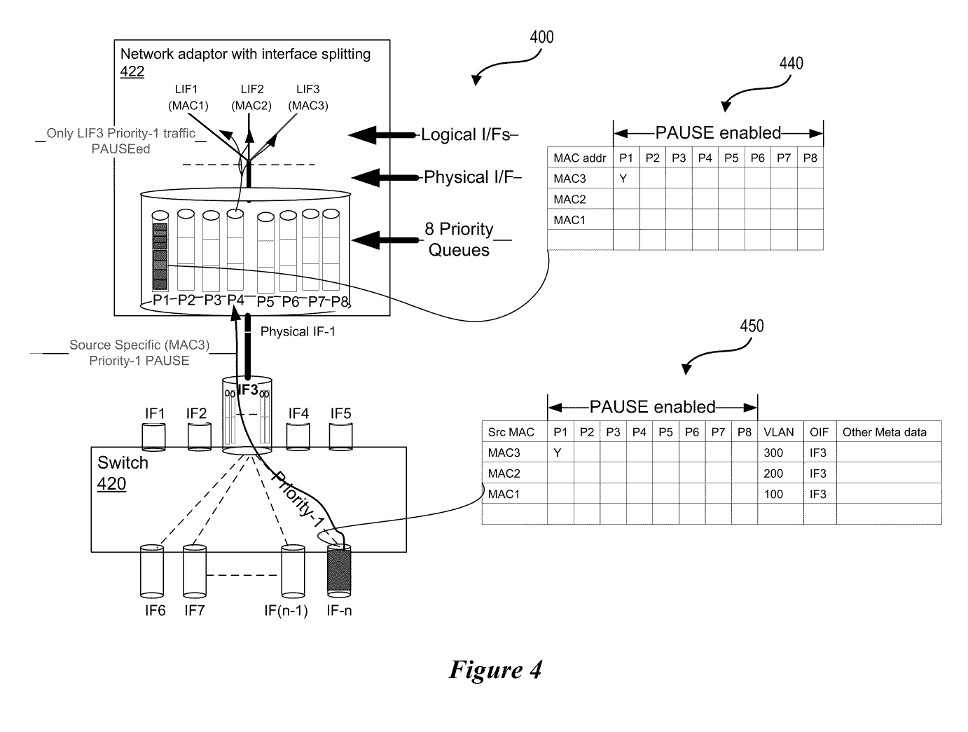

Referring to FIG. 4, an example of a system 400 which manages pauses on a per MAC and per priority pause status in network adapters and network switches is shown.

More specifically, the system 410 tracks the pause/resume status on each priority queue for each MAC address. The system 410 enables switches 420 and network adapters 422 (e.g., NICs or CNAs) to track the pause/resume status for each MAC address in a MAC address forwarding table 440. The system 410 includes a field (e.g., a one byte field) within the forwarding table 440 which specifies the pause/resume status for each priority. In certain embodiments, if the bit is true, then traffic from this MAC address is paused for the priority indicated by the bit number. If the bit is false, then traffic from this MAC address is not paused. The system 410 can include a network adapter table 440 as well as a switch table 450. The system 410 allows tracking of pause status on a per MAC basis.

It will be appreciated that different techniques can be used to determine the source contributing more packets which is causing the congestion. For example, a source based account or random early detection (RED) or weighted early detection (WRED) methods can be used. Also, rather than dropping a source, the system 410 enables use of packet information to determine the source address and generate the source specific pause frame packet.

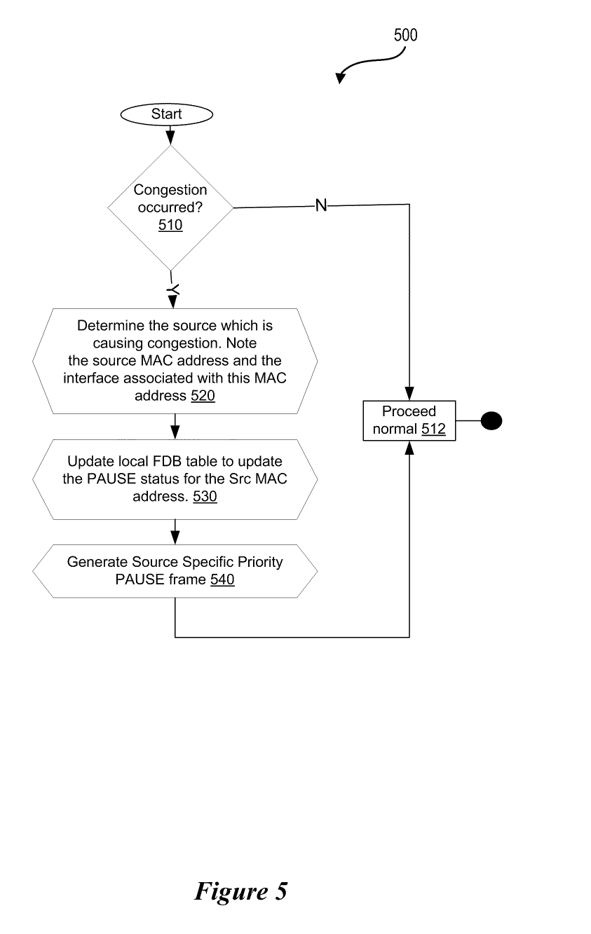

FIG. 5 shows a flow chart of a system 500 for performing a queue management operation for a congested switch port. During a queue management operation, at the congestion point (e.g., a switch), the node determines which packets are causing the congestion. In certain embodiments, a source address based accounting method is used to determine which source is causing the congestion. Upon identification of a source which generated the congestion, rather than generating a generic PFC PAUSE frame, the congested node now uses the source address to generate a source specific pause frame packet.

More specifically, at step 510, the system 500 determines whether any congestion has occurred. If no congestion has occurred, then the system 500 proceeds to function normally at step 512. If the system detects congestion, then the system determines the source which is causing the congestion at step 520. During the determination, the system identifies a source address (e.g., a MAC address) and an interface associated with the source address. Next, the system 500 updates a forwarding table (e.g., table 440) to reflect a pause status of the source address which corresponds to the source which is causing the congestion. Next, at step 550, the system 500 generates the source specific priority pause frame.

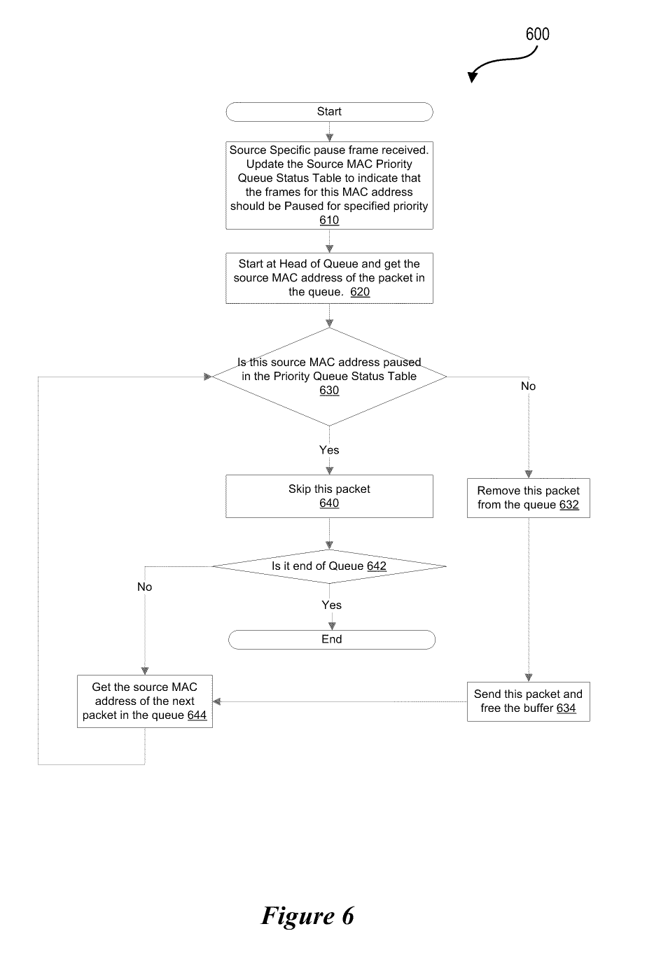

FIG. 6 shows a flow chart of a system 600 for generating a pause operation for a network adapter or switch which receives a source specific based pause frame. The system 600 performs a queuing function for the port receiving a source specific pause frame. Before sending the frame (e.g., over the network), the switch (or network adapter) checks to determine whether the traffic for the MAC address specified by the Source MAC Address field in the packet is paused. If the source is paused, then this packet is skipped and the next packet in the queue is processed. Because pause status is maintained as a bitmap within a table, the system 600 can easily determine whether a source specific pause operation is indicated.

More specifically, at step 610, the system 600 determines whether a source specific pause frame has been received. Upon receipt of a source specific pause frame, the source priority queue status table is updated to indicate that the frames corresponding to the particular address (e.g., a particular MAC address) should be paused for a specified priority. Next, at step 620, the system 600 starts at the head of the queue and obtains the source addresses of the packet in the queue. Next, at step 630, the system determines whether the source address corresponds to a paused source in the priority queue status table. If the address does not correspond to a paused source, then the packed is removed from the queue at step 632. Next, the packet is sent to its destination and removed from the queue at step 634.

If the source address corresponds to a paused source, then the packet corresponding to this source address is skipped at step 640.

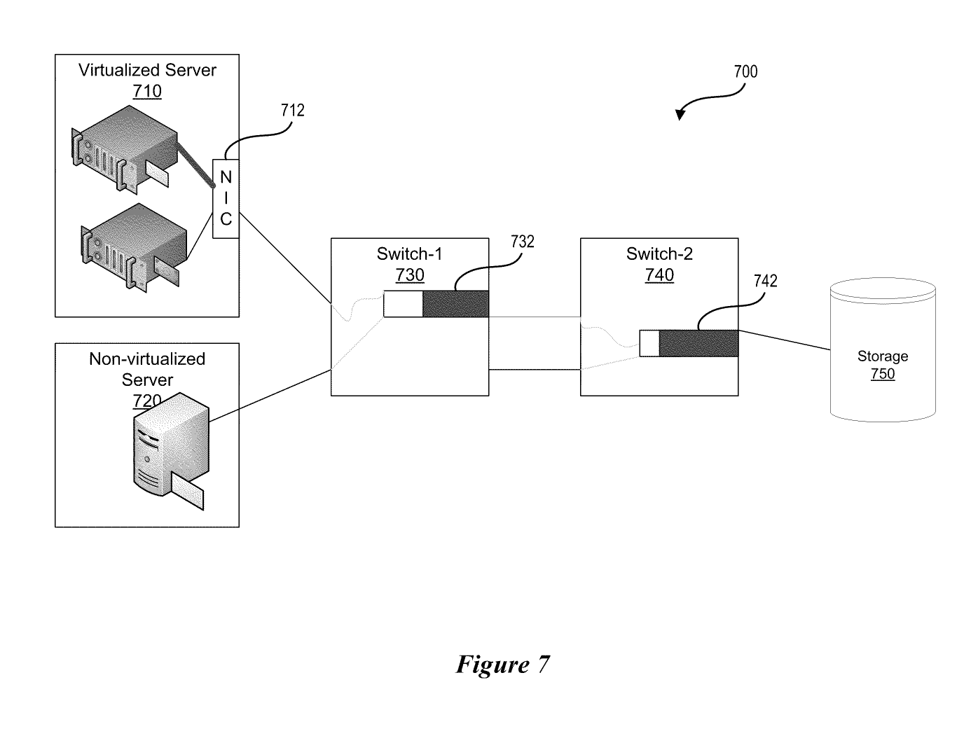

FIG. 7 shows a block diagram of an environment operating 700 with a source specific PFC. The environment 700 shows the generation and processing of a proposed pause frames in an end to end solution which includes a multi-hop Ethernet network. More specifically, the environment 700 includes a virtualized server system 710 which includes a NIC 712 as well as a plurality of virtualized servers 714, as well as a non virtualized server 720. The servers 710, 720 are coupled to a first switch 730 (Switch-1). The first switch 730 includes a first switch queue 732. The first switch 730 is coupled to a second switch 740 (Switch-2). The second switch 740 includes s second switch queue 742. The second switch 740 is coupled to storage 750.

By providing the source specific PFC, the NIC 712 pauses only the specific source on the specified priority. Also, when receiving a source specific PFC pause frame while processing an egress queue, the first switch 730 transmits packets from other sources. Also, the first switch 730 generates source specific PFC pause frame only on the ingress port (e.g., the first switch queue 732) that is indicated by the TDB tables.

The second switch 740 generates a PFC pause frame when a congested queue (e.g., the second switch queue 742) is detected. The switch 740 determines the source of the congestion and generates the source specific PFC pause frame to the source that is responsible for the congestion. The second switch 740 then uses its corresponding FDB table to identify the incoming port for the source MAC to send the source specific pause frame.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for enabling traffic for a particular source to be paused on a particular priority queue, the particular source corresponding to a logical link of a physical network link, the physical network link including a corresponding independent queue, the method comprising:
identifying the physical network link by a priority field;
determining when a particular source is responsible for network congestion;
generating a source specific pause frame, the source specific pause frame being directed to the particular source responsible for the congestion; and,
pausing traffic generated by the particular source in response to the source specific pause frame.

2. The method of claim 1 wherein:
the source specific pause frame conforms to a Data Center Bridging (DCB).

3. The method of claim 2 wherein:
the DCB standard includes a Priority Based Flow Control (PFC) capability, the source specific pause frame being included within PFC capability.

4. The method of claim 2 further comprising:
processing process packets in each queue of a network which conforms to the DCB standard.

5. The method of claim 1 wherein:
the priority field is identified within a virtual local area network (VLAN) header.

6. The method of claim 1 further comprising:
processing process queues and packets at a port receiving the source specific pause frame.

7. An apparatus for enabling traffic for a particular source to be paused on a particular priority queue, the particular source corresponding to a logical link of a physical network link, the physical network link including a corresponding independent queue, the apparatus comprising:
means for identifying the physical network link by a priority field;
means for determining when a particular source is responsible for network congestion;
means for generating a source specific pause frame, the source specific pause frame being directed to the particular source responsible for the congestion; and,
means for pausing traffic generated by the particular source in response to the source specific pause frame.

8. The apparatus of claim 7 wherein:
the source specific pause frame conforms to a Data Center Bridging (DCB).

9. The apparatus of claim 8 wherein:
the DCB standard includes a Priority Based Flow Control (PFC) capability, the source specific pause frame being included within PFC capability.

10. The apparatus of claim 8 further comprising:
means for processing process packets in each queue of a network which conforms to the DCB standard.

11. The apparatus of claim 7 wherein:
the priority field is identified within a virtual local area network (VLAN) header.

12. The apparatus of claim 7 further comprising:
means for processing process queues and packets at a port receiving the source specific pause frame.

13. A system comprising:
a source comprising a plurality of priority queues, the source corresponding to a logical link of a physical network link,
a computer readable memory, the computer readable memory storing a source specific priority based flow control (PFC) module for enabling traffic for a particular source to be paused on a particular priority queue, the particular source corresponding to a logical link of a physical network link, the physical network link including a corresponding independent queue, the source specific PFC module comprising instructions executable by a processor for:
for identifying the physical network link by a priority field;
determining when a particular source is responsible for network congestion;
generating a source specific pause frame, the source specific pause frame being directed to the particular source responsible for the congestion; and,
pausing traffic generated by the particular source in response to the source specific pause frame.

14. The system of claim 13 wherein:
the source specific pause frame conforms to a Data Center Bridging (DCB).

15. The system of claim 14 wherein:
the DCB standard includes a Priority Based Flow Control (PFC) capability, the source specific pause frame being included within PFC capability.

16. The system of claim 14, wherein the source specific PFC module further comprises instructions for:
processing process packets in each queue of a network which conforms to the DCB standard.

17. The system of claim 13 wherein:
the priority field is identified within a virtual local area network (VLAN) header.

18. The system of claim 14, wherein the source specific PFC module further comprises instructions for:
processing process queues and packets at a port receiving the source specific pause frame.
